(19) United States
(12) Patent Application Publication
(10) Pub. No.: US 2005/0112344 A1
(43) Pub. Date: May 26, 2005

(54) Apparatus and method for use in printed circuit board drilling applications

(76) Inventors: Sean M. Redfern, Newport Beach, CA (US); Paul St. John, Corona, CA (US); James J. Miller, Brea, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/922,382

(22) Filed: Aug. 19, 2004

Related U.S. Application Data
(60) Provisional application No. 60/496,436, filed on Aug. 20, 2003.

(51) Int. Cl. B32B 7/02

(52) U.S. Cl. 428/213; 428/211.1

(57) ABSTRACT

This invention relates to materials and methods of drilling printed circuit boards. In one embodiment, this invention provides a lubricated backup board comprising a core material, a lubricant, and an outer shell material and a process for using said backup board. In another embodiment, this invention provides an entry board comprising a lubricant and an outer shell material and a process for using said entry board. In preferred embodiments the lubricant layers are substantially separate and distinct layers. In preferred embodiments, adhesive is used to secure the layers together. In one embodiment, said processes allows for reuse and/or replacement of various layers of preferred backup and/or entry boards.

### RELATED APPLICATION DATA

This application claims priority under 35 U.S.C. 119(e) from provisional application Ser. No. 60/496,436 filed Aug. 20, 2003, entitled Apparatus And Method For Use In Printed Circuit Board Drilling Applications, the disclosure of which is incorporated in its entirety herein by reference.

### BACKGROUND OF THE INVENTION

1. Field of the Invention

This invention relates to materials and methods of drilling printed circuit boards.

2. Description of the Related Art

The use of printed circuit boards in the electronics industry has grown rapidly over the past several decades. In order for the printed circuit boards to be utilized, the boards must undergo a drilling process whereby multiple thru-holes and blind holes are drilled into each board. Generally, multiple boards having one or more layers of copper and/or prepeg are stacked on top of each other and drilled simultaneously. During this process the boards may become damaged due to one or more of the following: burring, contact with the pressure foot, and excessive heat from the drill bit. Backup and entry boards have been used to help improve this drilling process. Backup boards are generally a hard board that is placed at the bottom of the stack of printed circuit boards. Entry boards are generally placed at the top of and/or interspersed throughout the stack of printed circuit boards.

### SUMMARY OF THE INVENTION

In one embodiment, this invention relates to methods and materials for use in printed circuit board drilling applications. In one embodiment, there is provided a drilling process in which one or more printed circuit boards are stacked on top of a preferred backup board and drilled. In another embodiment, there is provided a drilling process in which an entry board is placed on top of one or more printed circuit boards which are then drilled. In other embodiments, a combination of backup and entry boards are used in the drilling process. In preferred embodiments backup boards comprising a core material, a lubricant, and an outer shell material are used. Preferably the lubricant is a substantially separate and distinct layer. In other preferred embodiments entry boards comprising a substantially separate and distinct lubricant layer and an outer shell material are used. Preferably the lubricant is a substantially separate and distinct layer.

In one embodiment, a preferred backup board comprises a first outer shell layer, one or more lubricant layers, a core material layer, one or more lubricant layers, and a second outer shell layer, wherein the layers are in the order recited. In another embodiment, the one or more lubricant layers are preferably substantially separate and distinct layers. In one embodiment, the one or more lubricant layers comprise polyethylene glycol and/or polyalkylene oxide compounds. In certain embodiments wherein more than one lubricant layer is present, the lubricants may be the same type and/or form or they may differ. In one embodiment a resistance sheet is used to provide support for one or more of the one or more lubricant layers. In other embodiments, the outer shell materials may be the same or they may differ. In one embodiment, the layers of preferred backup boards are secured together using an adhesive.

In one embodiment, a preferred entry board comprises a first outer shell layer, one or more lubricant layers, and a second outer shell layer, wherein the layers are in the order recited. In one embodiment, the one or more lubricant layers are preferably substantially separate and distinct layers. In one embodiment, the one or more lubricant layers comprise polyethylene glycol and/or polyalkylene oxide compounds. In certain embodiments wherein more than one lubricant layer is present, the lubricants may be the same type and/or form or they may differ. In one embodiment a resistance sheet is used to provide support for one or more of the one or more substantially separate and distinct lubricant layers. In other embodiments, the outer shell materials may be the same or they may differ. In one embodiment, the layers of preferred entry boards are secured together using an adhesive.

The layers of preferred backup and entry boards may be secured together using one or more of the following: adhesive, tabs, pins, straps, shrink wrap, tape, and other suitable securing devices. In a preferred embodiment, an adhesive is used. Suitable adhesives include, but are not limited to, epoxy, phenolic adhesive, urethane adhesive, and urea formaldehyde. In preferred embodiments utilizing an adhesive, the adhesive may cover the entire layer or only a portion of the layer.

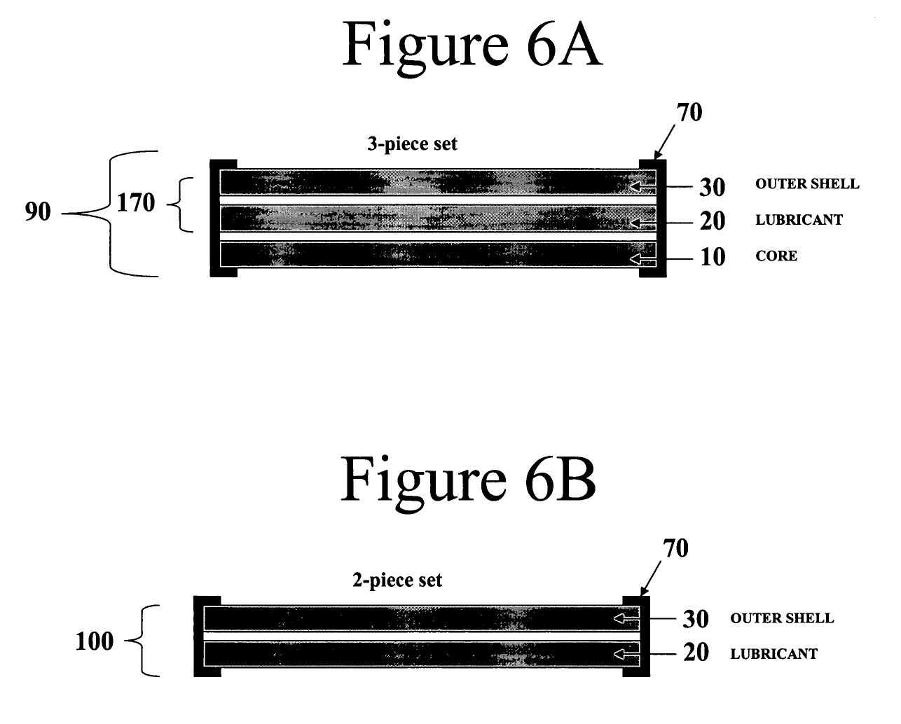

In one embodiment, see for example FIG. 6A, the drill operator will first place the three-piece set on the drill machine followed by one or more printed circuit boards. Once the operator is finished with the first set, he or she will remove the top two layers, leaving the core layer, and replace them with a new two-piece set. This allows for maximum use of each core material layer thereby reducing costs and providing an environmentally friendly product. Depending on the drilling requirements, it will be apparent to one of skill in the art how often the core layer will need to be flipped and replaced.

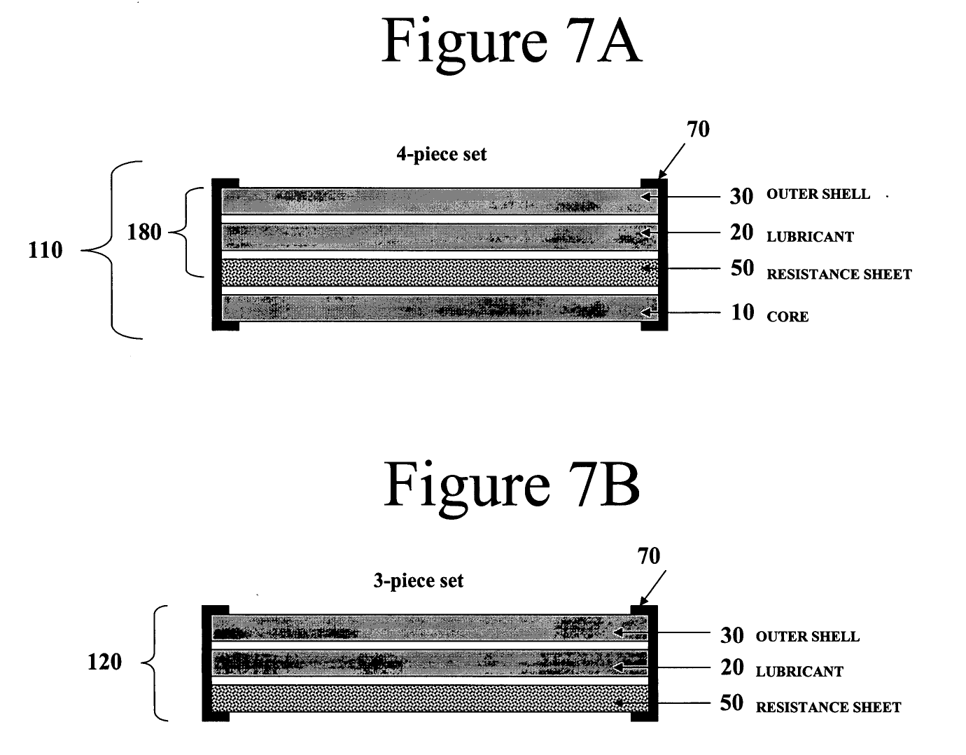

As shown in FIG. 7A an initial four-piece set is utilized. Once the operator is finished with the first set, he or she will remove the top three layers, leaving the core layer, and replace them with a new three-piece set. As one of skill in the art will appreciate, various combinations of layers may be used depending on the specific drilling application.

All of these embodiments are intended to be within the scope of the invention herein disclosed. These and other embodiments of the present inventions will become readily apparent to those skilled in the art from the following detailed description of preferred embodiments having reference to the attached figures, the invention not being limited to any particular preferred embodiment(s) disclosed.

### BRIEF DESCRIPTION OF THE DRAWINGS

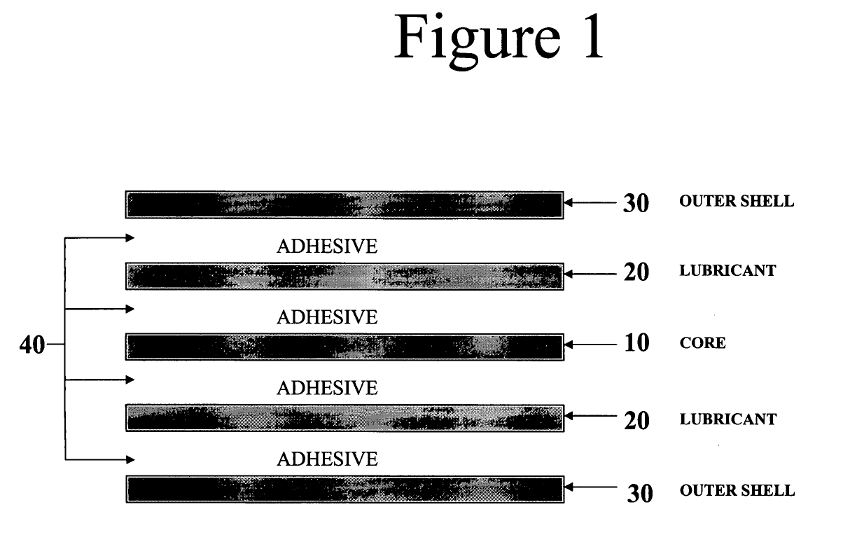

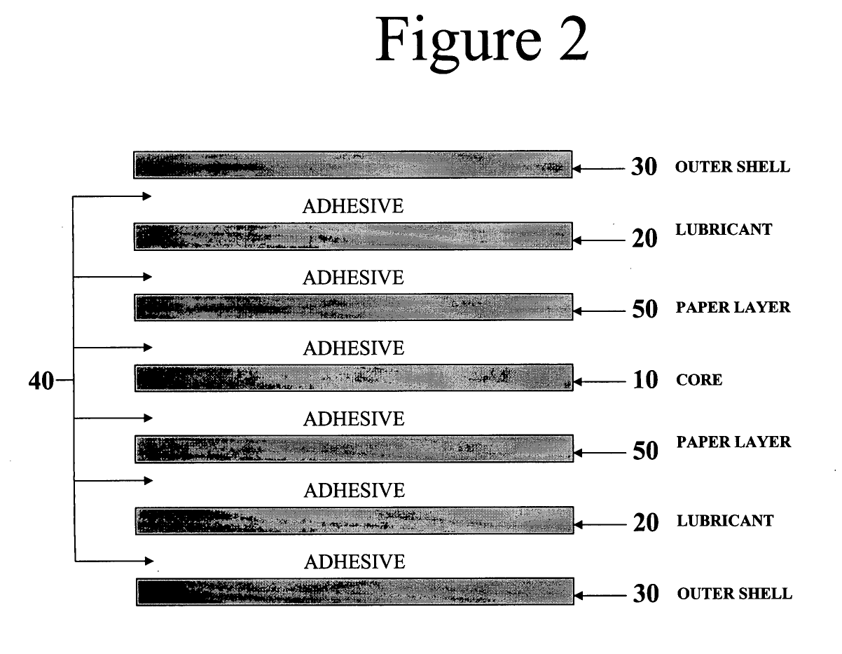

Referring to FIG. 1, there is illustrated an exploded cross-sectional view of one non-limiting embodiment of a backup board.

Referring to FIG. 2, there is illustrated an exploded cross-sectional view of one non-limiting embodiment of a backup board.

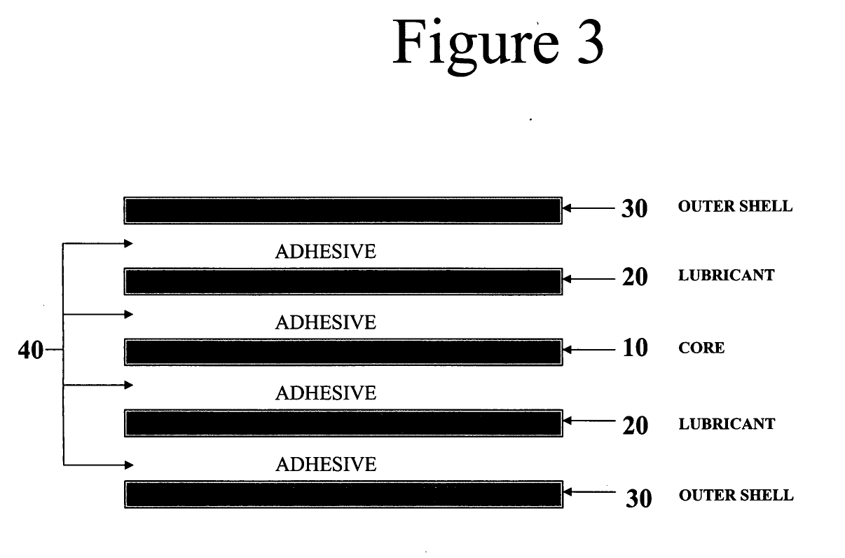

Referring to FIG. 3, there is illustrated an exploded cross-sectional view of one non-limiting embodiment of a entry board.

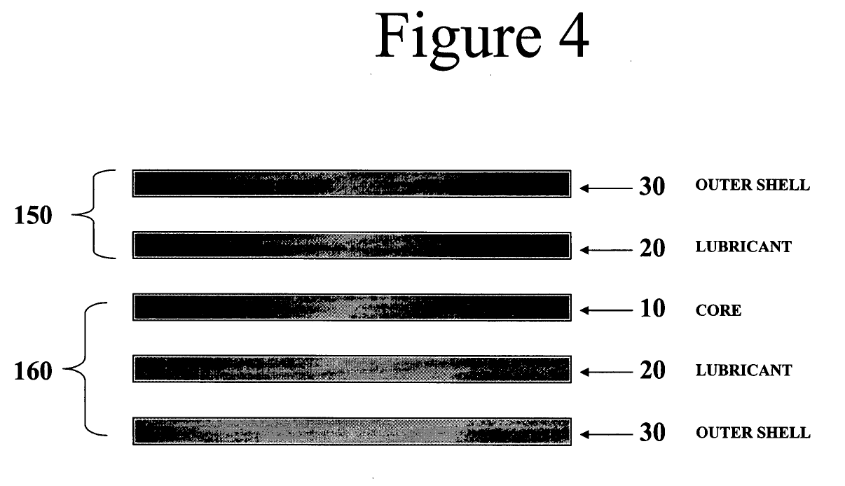

Referring to FIG. 4, there is illustrated an exploded cross-sectional view of one non-limiting embodiment of a backup board.

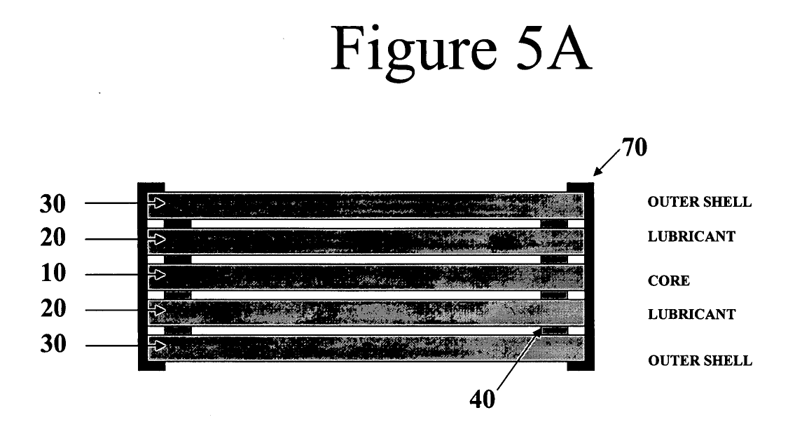

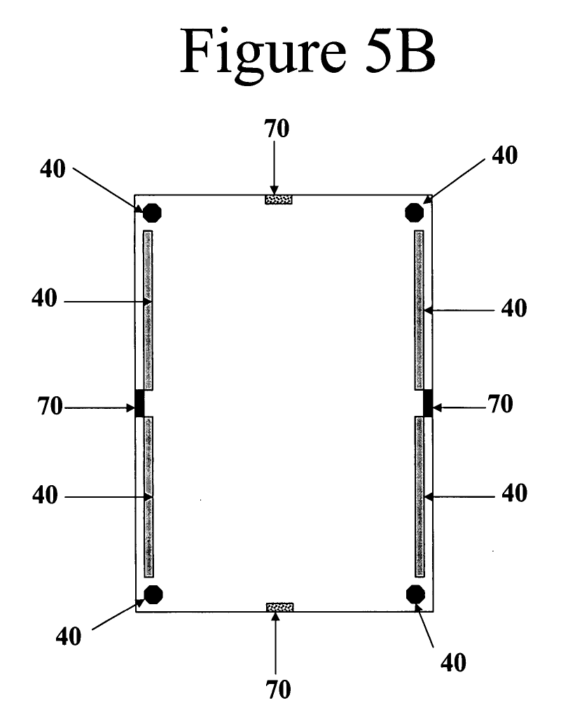

Referring to FIG. 5A there is illustrated an exploded cross-sectional view of one non-limiting embodiment of a backup board.

Referring to FIG. 5B there is illustrated an exploded top view of one non-limiting embodiment of a backup board.

Referring to FIGS. 6A and 6B there are illustrated exploded cross-sectional views of non-limiting embodiments of a backup board.

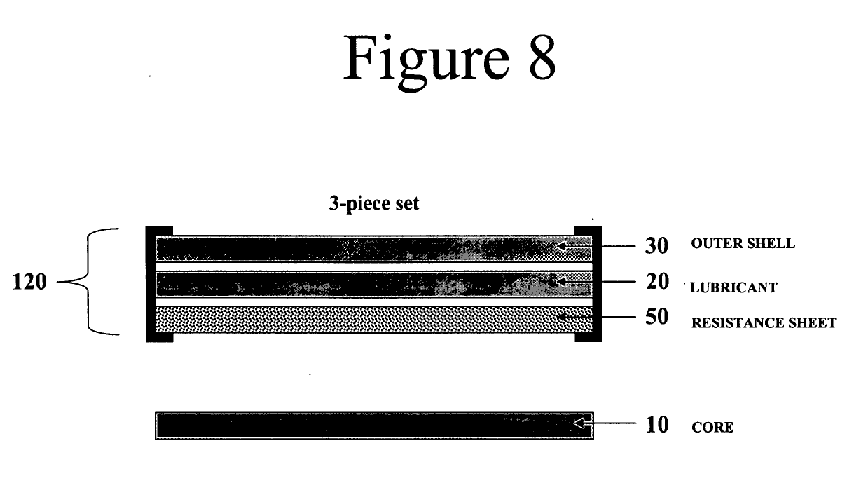

Referring to FIGS. 7A, 7B and 8 there are illustrated exploded cross-sectional views of non-limiting embodiments of a backup board.

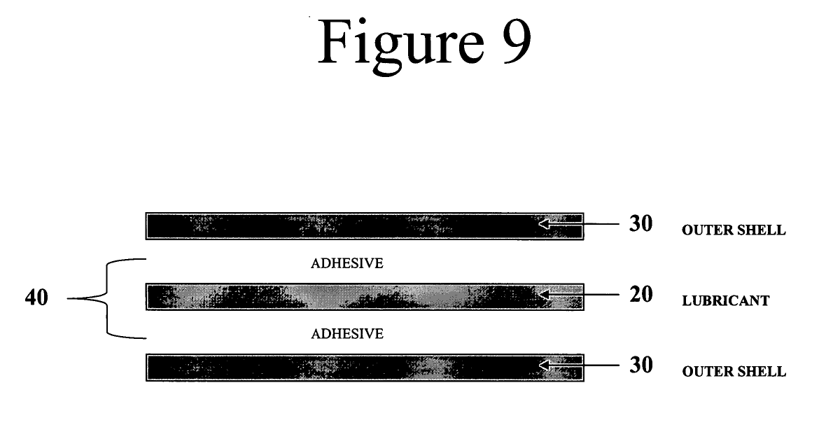

Referring to FIG. 9, there is illustrated an exploded cross-sectional view of one non-limiting embodiment of an entry board.

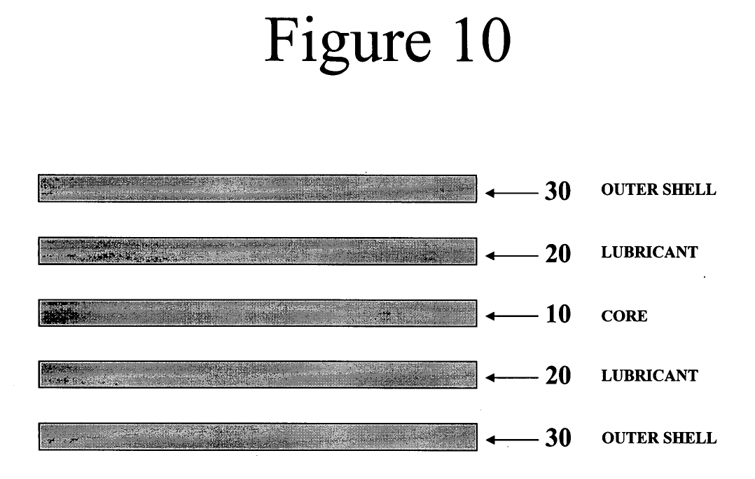

Referring to FIG. 10, there is illustrated an exploded cross-sectional view of one non-limiting embodiment an entry board.

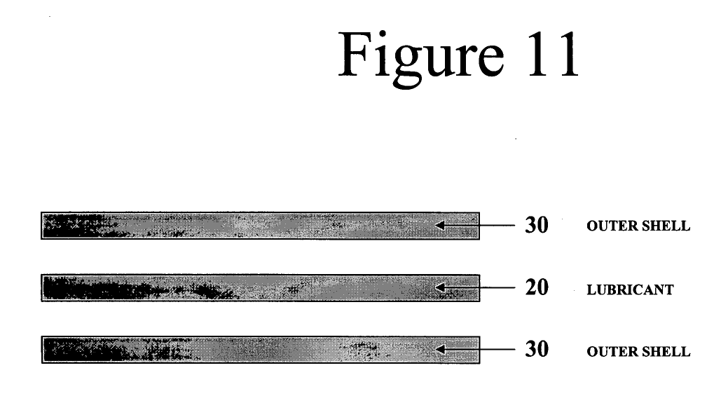

Referring to FIG. 11, there is illustrated an exploded cross-sectional view of one non-limiting embodiment of an entry board.

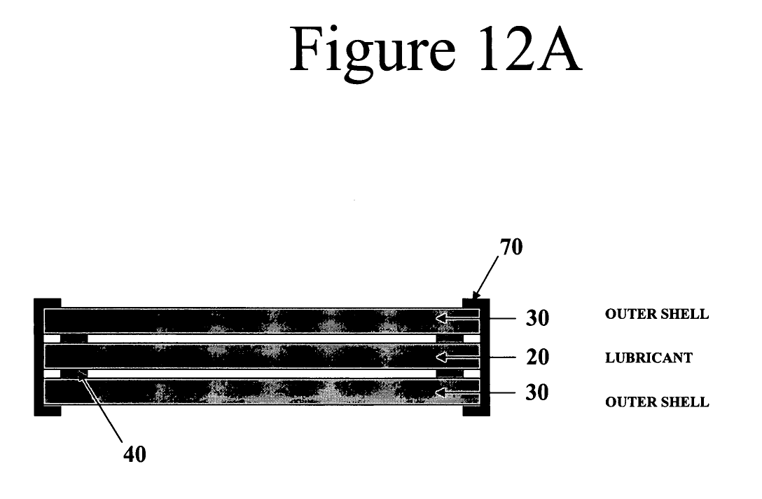

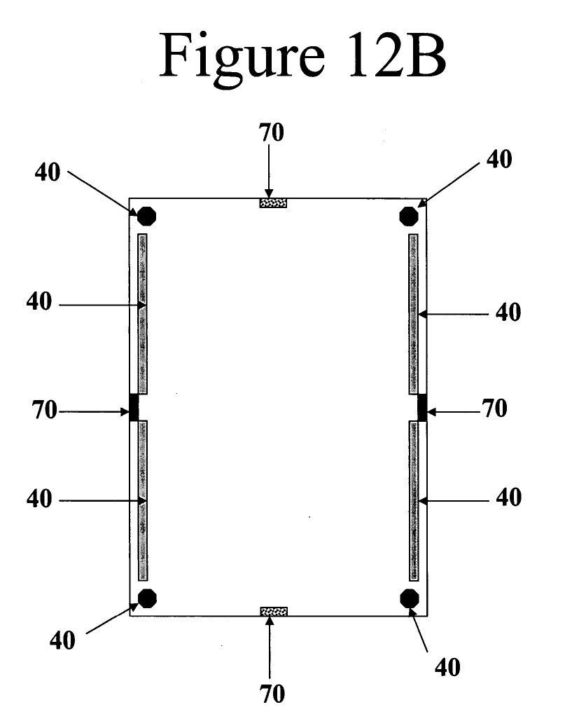

Referring to FIGS. 12A there is illustrated an exploded cross-sectional view of one non-limiting embodiment of an entry board.

Referring to FIGS. 12B there is illustrated a top view of one non-limiting embodiment of an entry board.

Figures are generally schematic in nature and are not to scale.

### DETAILED DESCRIPTION OF PREFERRED EMBODIMENTS

### A. General Description of Preferred Embodiments

In one embodiment, this invention relates to methods and materials for use in printed circuit board drilling applications. In one embodiment, there is provided a drilling process in which one or more printed circuit boards are stacked on top of a backup board according to embodiments disclosed herein, and drilled. In another embodiment, the drilling process includes the use of an entry board which is placed on top of the printed circuit boards to be drilled. Alternatively, the entry board may also be used in one or more places within the stack of printed circuit boards to be drilled. In another embodiment, the drilling process includes the use of both entry and backup boards. In preferred embodiments, backup boards comprising a core material, a lubricant, and an outer shell material are used. In preferred embodiments, entry boards comprise a lubricant and an outer shell material. Preferably the lubricant layers of preferred backup and entry boards are substantially distinct layers. In one embodiment, the layers of preferred backup and entry boards are secured together using an adhesive.

As used herein, the term “backup board” is a broad term used in its ordinary sense and includes, without limitation, boards placed on the bottom of a printed circuit board stack during drilling applications. As used herein, the term “entry board” is a broad term used in its ordinary sense and includes, without limitation, boards placed on the top, bottom, and/or within a stack of printed circuit boards during drilling applications. In preferred embodiments, entry boards comprise a lubricant and an outer shell material. In other embodiments, an entry board may further comprise a core. Preferably the lubricant layers are substantially distinct layers. In one embodiment, the layers of preferred entry boards are secured together using an adhesive. As used herein, the terms “drilling” and “drilling applications” are broad terms used in their ordinary sense and include, without limitation, a process of forming holes or channels in printed circuit boards.

Preferably drilling applications utilizing preferred backup and/or entry boards demonstrate one or more of the following characteristics: improved thru-hole or blind hole (decreased roughness, and decreased nailheading) quality, substantially no burring, improved drill accuracy, prolonged drill life, decreased drilling temperature, improved ability to increase amount of printed circuit boards drilled at once, and improved ability to drill through printed circuit boards that are typically becoming more difficult to drill through due to increased thicknesses of the boards and/or more abrasive circuit board components containing higher T_{g} materials (e.g. Polyimide resin, ceramic, ceramic-filled PTFE, Getek®).

In one preferred embodiment backup boards comprising a core, a lubricant as a substantially separate and distinct layer on each side of the core, and an outer shell material on each side of the substantially separate and distinct lubricant layer are used. See, for example, FIG. 4. The performance characteristics of the separate and distinct lubricant layer are optimized by isolating the substantially separate and distinct lubricant layer in this manner. As an example, the maximum amount of lubricant will contact the drill during penetration leading to maximum lubrication resulting in increased hole quality (roughness and nailheading), increased drill life, and the potential for drilling higher stack heights and/or printed circuit board thicknesses. Additionally, by incorporating a stable core and shell into this embodiment the backup board has increased overall stability and rigidity that results in improved handling characteristics and a reduction in burring and warpage or bending. As one of skill in the art will appreciate, these characteristics will benefit the drilling process.

In another preferred embodiment backup boards comprising a core, a lubricant as a substantially separate and distinct layer on each side of the core, and an outer shell on each side of the substantially separate and distinct lubricant layers may be bonded together by a substantially separate and distinct adhesive layer while maintaining the lubricant as a substantially separate and distinct layer in and of itself. See, for example, FIG. 1. The performance characteristics of the separate and distinct lubricant layers are optimized by isolating the lubricant layers in this manner. As an example, in this embodiment the maximum amount of lubricant will contact the drill during penetration leading to maximum lubrication resulting in increased hole quality (roughness and nailheading), increased drill life, and the potential for drilling higher stack heights and/or printed circuit board thicknesses. Additionally, by incorporating a stable core, shell, and adhesive into this embodiment the backup board has increased overall stability and rigidity that results in improved handling characteristics and a reduction in burring and warpage or bending. As one of skill in the art will appreciate, these characteristics will benefit the drilling process.

In other preferred embodiments entry boards comprising a core, a lubricant as a substantially separate and distinct layer on each side of the core and an outer shell on each side of the lubricant layer are used. See, for example, FIG. 4. The performance characteristics of the substantially separate and distinct lubricant layers are optimized by isolating the lubricant layers in this manner. As an example, the maximum amount of lubricant will contact the drill during penetration leading to maximum lubrication resulting in increased hole quality (roughness and nailheading), increased drill life, and the potential for drilling higher stack heights or printed circuit board thicknesses. Additionally, by incorporating a stable core and shell into this embodiment the entry board has increased overall stability and rigidity that results in improved handling characteristics, a reduction in burring, an improved bushing effect resulting in improved accuracy, and reduced warpage or bending that can cause debris buildup and location accuracy problems. As one of skill in the art will appreciate, these characteristics will benefit the drilling process.

In other preferred embodiments entry boards comprising a core, a lubricant as a substantially separate and distinct layer on each side of the core, and an outer shell on each side of the substantially separate and distinct lubricant layers may be bonded together by a substantially separate and distinct adhesive layer while maintaining the lubricant as a separate and distinct layer in and of itself. See, for example, FIG. 3. The performance characteristics of the substantially separate and distinct lubricant layers are optimized by isolating the lubricant layers in this manner. As an example, in this embodiment the maximum amount of lubricant will contact the drill during penetration leading to maximum lubrication resulting in increased hole quality (roughness and nailheading), increased drill life, and the potential for drilling higher stack heights and/or printed circuit board thicknesses. Additionally, by incorporating a stable core, shell, and adhesive into this embodiment the entry board has increased overall stability and rigidity that results in improved handling characteristics, a reduction in burring, an improved bushing effect resulting in improved accuracy, and reduced warpage or bending that can cause debris buildup and location accuracy problems. As one of skill in the art will appreciate, these characteristics will benefit the drilling process.

In other preferred embodiments entry boards comprising a lubricant as a substantially separate and distinct layer and outer shells on each side of the substantially separate and distinct lubricant layer are used. See, for example, FIG. 11. The performance characteristics of the substantially separate and distinct lubricant layer are optimized by isolating the lubricant layer in this manner. As an example, the maximum amount of lubricant will contact the drill during penetration leading to maximum lubrication resulting in increased hole quality (roughness and nailheading), increased drill life, and the potential for drilling higher stack heights and/or printed circuit board thicknesses. Additionally, by incorporating stable shells into this embodiment the entry board has increased overall stability and rigidity that results in improved handling characteristics, a reduction in burring, an improved bushing effect resulting in improved accuracy, and reduced warpage or bending that can cause debris buildup and location accuracy problems. As one of skill in the art will appreciate, these characteristics will benefit the drilling process.

In other preferred embodiments entry boards comprising a lubricant as a substantially separate and distinct layer and outer shells on each side of the substantially separate and distinct lubricant layer may be bonded together by a substantially separate and distinct adhesive layer while maintaining the lubricant as a substantially separate and distinct layer in and of itself. See, for example, FIG. 9. The performance characteristics of the substantially separate and distinct lubricant layer are optimized by isolating the lubricant layer in this manner. As an example, in this embodiment the maximum amount of lubricant will contact the drill during penetration leading to maximum lubrication resulting in increased hole quality (roughness and nailheading), increased drill life, and the potential for drilling higher stack heights and/or printed circuit board thicknesses. Additionally, by incorporating stable shells and adhesive into this embodiment the entry board has increased overall stability and rigidity that results in improved handling characteristics, a reduction in burring, an improved bushing effect resulting in improved accuracy, and reduced warpage or bending that can cause debris buildup and location accuracy problems. As one of skill in the art will appreciate, these characteristics will benefit the drilling process.

### B. Preferred Materials

In a preferred embodiment, a backup board comprises a core material, a lubricant, and an outer shell material. In another preferred embodiment, an entry board comprises an outer shell material and a lubricant. In one embodiment, an entry board further comprises a core. Preferably the lubricant layers are substantially separate and distinct layers. In one embodiment, the layers of preferred backup and entry boards are secured together using an adhesive. Preferably the adhesive layers are substantially separate and distinct layers.

As presently contemplated, suitable core materials include, but are not limited to, high-density fiberboard (HDF), medium density fiberboard (MDF), metal (e.g. aluminum or copper), metal alloys, paper, melamine, random fiber mats, plastic, chip board, particle board, phenolic alone or supported with paper, cloth, glass fiber and the like (e.g. phenolic similar to prepeg used in circuit boards), solid or laminated phenolic sheets, and the like. In one embodiment, core thickness preferably ranges from about 0.0001 inches to about 0.125 inches, but also including about 0.0005, 0.001, 0.005, 0.01, 0.05, 0.055, 0.06, 0.065, 0.07, 0.075, 0.08, 0.085, 0.09, 0.095, 0.10, 0.105, 0.110, 0.115, and 0.12 inches and ranges encompassing these amounts. In one preferred embodiment, the core thickness is from about 0.085 inches to about 0.095 inches, preferably from about 0.087 inches to about 0.088 inches.

As presently contemplated, suitable lubricants include, but are not limited to, polyethylene glycol, polypropylene glycol, and/or polyalkylene oxide compounds, preferably polyethylene oxide, polypropylene oxide, and combinations thereof. In one embodiment, suitable lubricants include, but are not limited to, those in the form of an extruded lubricant layer, a hot melt coating lubricant layer or cast hot melt lubricant layer, or as a lubricant saturated paper layer. One such suitable lubricant is a water-soluble polyethylene glycol based lubricant. For example, a suitable lubricant includes, but is not limited to, a polyalkylene oxide compound obtained by addition polymerizing alkylene oxide mainly composed of ethylene oxide into an organic compound having two active hydrogen group. Other suitable lubricants are described U.S. Pat. No. 5,507,603 to Nakano et al.

In one embodiment, lubricant thickness preferably ranges from about 0.0001 inches to about 0.03 inches, but also including about 0.001, 0.002, 0.003, 0.004, 0.005, 0.006, 0.007, 0.008, 0.009, 0.01, 0.015, 0.02, and 0.025 inches and ranges encompassing these amounts. In another embodiment, lubricant thickness preferably ranges from about 0.0001 inches to about 0.125 inches, but also including about 0.0005, 0.001, 0.005, 0.01, 0.05, 0.055, 0.06, 0.065, 0.07, 0.075, 0.08, 0.085, 0.09, 0.095, 0.10, 0.105, 0.110, 0.115, and 0.12 inches and ranges encompassing these amounts. In a preferred embodiment, the lubricant thickness is about 0.003 inches. Preferred lubricants preferably demonstrate one or more of the following characteristics depending on the application: the lubricant hardens when cooled, the lubricant liquefies when heated, is water soluble, is chemically soluble, provides lubrication at desired drilling temperature, lubricant deposits on the hole wall are readily removable (e.g. removable with high pressure wash), does not interfere with post-drilling processes, is easy to handle, is stable (e.g. does not substantially degrade during the life of the product), adds additional rigidity to the board.

As presently contemplated, suitable outer shell materials include, but are not limited to, aluminum, aluminum alloys, non-aluminum metals (e.g. copper), non-aluminum metal alloys, resin, film, resin film, melamine, phenolic (e.g. medium density overlay glue film), UV cured film, plastic, acrylic, polyurethane alone, polyurethane supported on paper, resin impregnated paper, and coated or uncoated paper. Preferably, although not required, suitable outer shell materials will provide added rigidity to the backup board. In one embodiment, outer shell thickness preferably ranges from about 0.0001 inches to about 0.03 inches, but also including about 0.0005, 0.001, 0.002, 0.003, 0.004, 0.005, 0.006, 0.007, 0.008, 0.009, 0.01, 0.015, 0.02, and 0.025 inches and ranges encompassing these amounts. For example, in one embodiment a preferred outer shell is aluminum alloy 3003 H19 ranging in thickness from about 0.001 to about 0.002 inches thick, but also including about 0.00125, 0.0015, 0.00175 inches and ranges encompassing these amounts. In another embodiment, outer shell thickness preferably ranges from about 0.0001 inches to about 0.125 inches, but also including about 0.005, 0.01, 0.05, 0.055, 0.06, 0.065, 0.07, 0.075, 0.08, 0.085, 0.09, 0.095, 0.10, 0.105, 0.110, 0.115, and 0.12 inches and ranges encompassing these amounts. In another embodiment, a preferred outer shell is a phenolic paper. For example, in one embodiment a phenolic glue film is used.

Other embodiments may include outer shell materials comprising paper coated with adhesive, plastic, melamine, ultra violet (UV) curable film, or resin coatings. In one embodiment the adhesive is an epoxy. In one embodiment, paper is coated with a UV cured epoxy coating. For example, a cationic epoxy may be used as part of the UV top coat. One suitable cationic epoxy has a viscosity range of from about 50 to about 500 cps (Brookfield, RVF4 @ 10 rpm). Other cationic epoxies may have varying viscosity ranges that are also suitable in preferred embodiments. In another embodiment an acrylic resin impregnated paper with an electron beam cured acrylic topcoat is used. In another embodiment, the coated paper comprises a UV cured epoxy coated glassine paper. In one embodiment, a preferred outer shell is coated paper with a thickness ranging from about 0.001 to about 0.003 inches, including about 0.0015, 0.002, 0.0025 inches and ranges encompassing these amounts. Preferred outer shell materials preferably demonstrate one or more of the following characteristics depending on the application: provide a moisture barrier, support for handling, provide a bushing effect for improved accuracy, protect against pressure foot damage related to lose debris and/or a damaged pressure foot, are hard, are minimally abrasive so as not to degrade the drill bit and by extension the hole quality, are substantially flat, are substantially smooth, provide substantially no contamination of other printed circuit manufacturing processes.

In one embodiment, a preferred backup board further comprises a paper layer, also referred to herein as a resistance sheet. As presently contemplated, suitable paper layers include but are not limited to coated or uncoated paper. For example, phenolic paper or coated paper as described herein supra may be used. In one embodiment, paper layers preferably demonstrate one or more of the following characteristics: provide rigidity sufficient to decrease burring without substantially decreasing drill life, are substantially non-contaminating, and are substantially flat.

In one embodiment, a preferred backup board further comprises an adhesive. In one embodiment, adhesive thickness preferably ranges from about 0.0001 inches to about 0.005 inches, but also including about 0.0005, 0.0008, 0.001, and 0.003 inches and ranges encompassing these amounts. In another embodiment, the adhesive is an epoxy. Preferred epoxies are preferably room temperature curable with accelerated cure rate at elevated temperatures (e.g. 15 minute cure time at 200° F.) and/or compatible with post drilling printed circuit processes (e.g. non-contaminating to other printed circuit processes). In certain embodiments, it is desirable to have a shorter cure time as this allows for decreased production time. In other embodiments, if the board is heated it is preferable that the curing temperature of the epoxy does not significantly exceed the melt temperature of the lubricant. In one embodiment, preferred epoxies include, but are not limited to, two-part room temperature cured epoxies, polyimide cured epoxies, two-part Bisphenol A epoxies, and diglycidyl ether of Bisphenol A epoxies. In one embodiment, the epoxy has a resin base and a curing agent wherein the resin base has a viscosity ranging from about 3500 to about 4500 centipoise (Brookfield #4 at 20 rpm, 77° F.) and the curing agent has a viscosity ranging from about 3000 to about 4000 centipoise (Brookfield #4 at 20 rpm, 77° F.). In another preferred embodiment, an epoxy resin is used. Those of skill in the art will understand however that other suitable epoxies and/or adhesives may be used.

### C. Detailed Description of the Drawings

Referring to FIG. 1, there is illustrated a non-limiting embodiment of a backup board comprising an HDF core 10, a layer of lubricant saturated paper 20 on each side of the core, followed by an outer shell 30 on each side, wherein each layer is attached to the next layer using a distinct layer of adhesive 40. The adhesive may cover substantially all of the core 10, substantially separate and distinct lubricant layer 20, and outer shell 30 layers or it may cover only a portion of these layers. In one embodiment (not illustrated), the core 10 is a HDF core, the substantially separate and distinct lubricant layer 20 is a layer of lubricant saturated paper or an extruded lubricant layer on each side of the HDF core, the outer shell 30 is aluminum or paper, wherein each layer is attached to the next layer using a distinct layer of adhesive 40 which is an epoxy.

Referring to FIG. 2, there is illustrated a non-limiting embodiment of a backup board comprising an HDF core 10, a paper layer 50 on each side of the core, a layer of lubricant saturated paper 20 on top of each paper layer, followed by an outer shell 30 on each side, wherein each layer is attached to the next layer using a distinct layer of adhesive 40.

Referring to FIG. 3, there is illustrated a non-limiting embodiment of an entry board comprising an HDF core 10, a layer of lubricant saturated paper 20 on each side of the core, followed by an outer shell 30 on each side, wherein each layer is attached to the next layer using a distinct layer of adhesive 40. The adhesive may cover substantially all of the core 10, substantially separate and distinct lubricant layer 20, and outer shell 30 layers or it may cover only a portion of these layers. In one embodiment (not illustrated), the core 10 is a HDF core, the substantially separate and distinct lubricant layer 20 is a layer of lubricant saturated paper or an extruded lubricant layer on each side of the HDF core, the outer shell 30 is aluminum or paper, wherein each layer is attached to the next layer using a distinct layer of adhesive 40 which is an epoxy.

Referring to FIG. 4, there is illustrated a non-limiting embodiment of a backup board comprising a core 10, substantially separate and distinct lubricant layer 20 on each side of the core, an outer shell 30 on the outside of each side of the board, wherein the five layers are provided to the drill operator as one bundle wherein the layers are not attached using an adhesive. In another embodiment (not illustrated), the board is attached using a removable tab or similar attachment. In one embodiment (not illustrated), the core 10 is an HDF core, the substantially separate and distinct lubricant layer 20 is a layer of extruded lubricant or lubricant saturated paper on each side of the core, the outer shell 30 on the outside of each side of the board is aluminum or paper, wherein the five layers are provided to the drill operator as one bundle wherein the layers are not attached using an adhesive. Alternatively, the layers 150 and 160 may be attached to each other using a removable tab system (not illustrated) wherein the tab is removed to replace the used two layers 150 with a new two layers 150 during the drilling process.

Referring to FIGS. 5A and 5B there is illustrated a non-limiting embodiment of a backup board comprising a core 10, a substantially separate and distinct lubricant layer 20 on each side of the core 10, an outer shell 30 on the outside of each side of the board. In one embodiment (not illustrated), the core is an HDF core 10, the substantially separate and distinct lubricant layer 20 is a layer of extruded lubricant or a saturated paper layer, an outer shell 30 on the outside of each side of the board. These figures illustrate various attachment alternatives.

In FIG. 5A, a side view of an embodiment utilizing tab 70 and adhesive 40 attachment is shown. The tabs 70 and adhesive 40 may be used alone or in combination with each other. The brackets on each end depict tabs 70 while the smaller rectangles between layers depict adhesive 40 placement. The tab(s) may extend for the entire length of the board or the tab(s) may extend for only a portion of the board. There may be multiple tabs or a single tab. The tab 70 may contact three sides of the board or five sides of the board (e.g. an end cap tab). The tab 70 may be, but is not limited to, a biased or sized to fit tab. The adhesive 40 is shown as covering only a portion of the layers it is in contact with, in other embodiments the adhesive may cover differing portions of the layers it contacts or it may cover substantially all of one or more layers.

FIG. 5B depicts a top view of a board that illustrates alternate placement of tabs 70 and adhesive 40. In another embodiment, the tabs may also line the entire side or sides of a stack of printed circuit boards keeping all layers square and aligned with each other. The adhesive may cover only a portion of one or more layers or it may cover substantially all of one or more layers. Those of skill in the art will recognize that any suitable combination of a distinct layer(s) of adhesive and/or tabs in various placements may be used.

Referring to FIGS. 6A and 6B there is illustrated a non-limiting embodiment of a backup board comprising a core 10, a substantially separate and distinct lubricant layer 20 on one side of the core 10, an outer shell 30 on the outside of each side of the board. In one embodiment, the core 10 is an HDF core, the substantially separate and distinct lubricant layer 20 is an extruded lubricant or a saturated paper layer, the outer shell 30 is aluminum or paper. The layers are attached using a tab 70 system which allows the drill operator to remove a portion of the backup board during the drilling process. As illustrated here, in a preferred drilling process the drill operator will initially place a 3-piece 90 backup board, FIG. 6A, and one or more printed circuit boards on the drill machine. Once the operator has finished drilling a first set of printed circuit boards, the operator will remove the drilled printed circuit boards and the top two layers 170 of the 3-piece 90 backup board. The drill operator will then place a new two-piece 100 set, FIG. 6B, of backup board layers on the remaining core 10 piece. One of skill in the art will recognize the frequency in which the entire set must be replaced depending on the specific drilling application.

Alternatively, the operator will place the three piece set 90, FIG. 6A, on the drill machine, with the outer shell in contact with the drill machine, and then place the two piece set 100 on top of the three piece set 90, wherein the substantially separate and distinct lubricant layer 20 layer of the two piece set 100 is in direct contact with the core 10 of the three piece set 90. After drilling one or more printed circuit boards the drill operator will remove the used two piece set 100 and replace it with a new set 100. One of skill in the art will recognize the frequency in which the entire set must be replaced depending on the specific drilling application.

Referring to FIG. 7A there is illustrated a non-limiting embodiment of a backup board comprising a core 10, a resistance sheet 130 in on one side, a substantially separate and distinct lubricant layer 20 on top of the resistance sheet 130, and an outer shell 30. In one embodiment (not illustrated), the core 10 is HDF and the substantially separate and distinct lubricant layer 20 is an extruded lubricant. As illustrated in FIG. 7A, in one embodiment a 4-piece 110 backup board set is attached using a tab 70 system which allows the drill operator to remove a portion of the set 180 during the drilling process. As illustrated here, in a preferred drilling process the drill operator will initially place a 4-piece 110 backup board set and one or more printed circuit boards on the drill machine with the core of the 110 backup board set facing the drill machine and the outer shell 30 facing the bottom of the printed circuit board or stack of boards. Once the operator has finished drilling the printed circuit board(s), the operator will remove the top three backup board layers 180 and replace them with a new three-piece 120 backup board set.

Alternatively, the operator will place the four piece set 110, FIG. 7A, on the drill machine, with the outer shell in contact with the drill machine, and then place the three piece set 120 on top of the four piece set 110, wherein the resistance sheet 50 of the three piece set 120 is in direct contact with the core 10 of the four piece set 110. After drilling one or more printed circuit boards the drill operator will remove the used three piece set 120 and replace it with a new set 120. One of skill in the art will recognize the frequency in which the entire set must be replaced depending on the specific drilling application.

In another embodiment, as illustrated in FIG. 8, the 3-piece 120 backup board set is attached using tabs 70 while the core 10 piece is separately placed on the drill machine by the drill operator. The 3-piece 120 backup board set should be replaced at the end of each drilling cycle. One of skill in the art will know when a drilling cycle will require a change in the 3-piece 120 backup board set. One of skill in the art will recognize the frequency in which the core 10 piece must be replaced depending on the specific drilling application.

Referring to FIG. 9, there is illustrated a non-limiting embodiment of an entry board comprising an outer shell 30 on the outside of each side of the board, a substantially separate and distinct inner layer of lubricant 20, wherein the layers are attached using a substantially separate and distinct layer of adhesive 40. The adhesive 40 may cover substantially all of one or more layers or only a portion thereof. In another embodiment (not illustrated), the entry board comprises two or more layers of substantially separate and distinct lubricant layers. In one embodiment the substantially separate and distinct lubricant layer 20 is a saturated paper layer and/or an extruded lubricant layer. In certain embodiments wherein more than one substantially separate and distinct lubricant layer is present, the lubricants may be the same type and/or form or they may differ. In other embodiments, the outer shell materials may be the same or they may differ. For example, one side may have one outer shell of phenolic and the other side an outer shell of aluminum.

Referring to FIG. 10, there is illustrated a non-limiting embodiment of an entry board comprising a core 10, a substantially separate and distinct layer of lubricant 20 on each side of the core, an outer shell 30 on the outside of each side of the board, wherein the five layers are provided to the drill operator as one bundle wherein the layers are not attached using an adhesive. In another embodiment (not illustrated), the board is attached using a removable tab or similar attachment. In one embodiment (not illustrated), the core 10 is a paper core, the substantially separate and distinct lubricant layer 20 is a layer of extruded lubricant or lubricant saturated paper on each side of the core, the outer shell 30 on the outside of each side of the board is aluminum or paper, wherein the five layers are provided to the drill operator as one bundle wherein the layers are not attached using an adhesive

Referring to FIG. 11, there is illustrated a non-limiting embodiment of an entry board comprising an outer shell 30 on each side of the entry board, a substantially separate and distinct layer of lubricant 20 (e.g. extruded lubricant or lubricant saturated paper), wherein the three layers are provided to the drill operator as one bundle without an adhesive. In another embodiment (not illustrated), the entry board comprises two or more substantially separate and distinct layers of lubricant (e.g. extruded lubricant and/or lubricant saturated paper). In certain embodiments wherein more than one lubricant layer is present, the lubricants may be the same type and/or form or they may differ. In other embodiments, the outer shell materials may be the same or they may differ. For example, one side may have one outer shell of phenolic and one outer shell of aluminum.

Referring to FIGS. 12A and 12B there is illustrated a non-limiting embodiment of an entry board comprising an outer shell 30 on each side of the board and a layer of lubricant 20 (e.g. extruded lubricant or a lubricant saturated paper layer). In another embodiment (not illustrated), the entry board comprises two or more layers of lubricant (extruded lubricant and/or lubricant saturated paper). In certain embodiments wherein more than one lubricant layer is present, the lubricants may be the same type and/or form or they may differ. In other embodiments, the outer shell materials may be the same or they may differ. For example, one side may have one outer shell of phenolic and the other side an outer shell of aluminum. These figures illustrate various attachment alternatives.

In FIG. 12A, a side view of an embodiment utilizing tab 70 and adhesive 40 attachment is shown. The tabs 70 and adhesive 40 may be used alone or in combination with each other. The brackets on each end depict tabs 70 while the smaller rectangles between layers depict adhesive 40 placement. The tab(s) may extend for the entire length of the board or the tab(s) may extend for only a portion of the board. There may be multiple tabs or a single tab. The tab 70 may contact three sides of the board or five sides of the board (e.g. an end cap tab). The tab 70 may be, but is not limited to, a biased or sized to fit tab. The adhesive 40 is shown as covering only a portion of the layers it is in contact with, in other embodiments the adhesive may cover differing portions of the layers it contacts or it may cover substantially all of one or more layers.

FIG. 12B depicts a top view of an entry board illustrating alternate placement of tabs 70 and adhesive 40. In another embodiment, the tabs 70 may also line the entire side or sides of a stack of printed circuit boards keeping all layers square and aligned with each other. The adhesive may cover only a portion of one or more layers or it may cover substantially all of one or more layers. Those of skill in the art will recognize that any suitable combination of a distinct layer(s) of adhesive and/or tabs in various placements may be used.

One of skill in the art will understand that in embodiments described herein comprising more than one substantially separate and distinct layer of lubricant, the lubricant may be the same type and/or form or they may differ. Those of skill in the art will also understand that in certain embodiments described herein, the outer shell materials may be the same or they may differ.

One of skill in the art will understand that the non-limiting embodiments depicted in the Figures described above have been exaggerated for ease of understanding. The Figures depict non-limiting embodiments wherein the individual layers have been exaggerated to illustrate each layer. One of skill in the art will understand that the end product will appear to the end user as a single board with distinct layers.

### D. Preferred Backup Boards and Processes Using Preferred Backup Boards

An advantage of preferred backup and entry boards is the flexibility in which the boards are constructed. In preferred embodiments, one of skill in the art can vary one or more of the following items depending on their drilling needs: the outer shell materials, the number of layers of lubricant, the type of lubricant, the form of lubricant, the placement of lubricant, and the choice of core material. In one embodiment, an advantage of preferred backup and entry boards is that the separation of the substantially separate and distinct lubricant layer from the other layers allows for optimization of the lubricant's properties on the drill bit. It is believed that the separation of the lubrication layer allows for an increase in the amount of lubrication provided to the drill by preferred backup and entry boards. Increased lubrication reduces the heat generated by the drill bit which helps reduce damage to the hole wall and increases the life of the drill bit. In embodiments utilizing adhesive, it is believed that the adhesive acts as a barrier layer that helps the lubricant better surround and contact the drill without allowing the drill bit to become clogged by the debris as seen in other lubricated products. This is advantageous in that a reduction in excess debris on the drill bit reduces drill breakage and accuracy reduction due to the excess debris. In embodiments utilizing adhesive, it is believed that the adhesive provides additional stability and rigidity to the board, which helps improve handling and location accuracy.

In the broadest sense, a preferred backup board comprises a core material, one or more lubricant layers, and an outer shell material. In the broadest sense, a preferred entry board comprises one or more lubricants and an outer shell material. In preferred embodiments utilizing two outer shells, the outer shell materials may be the same or they may be different. In other preferred embodiments utilizing more than one layer of lubricant, the lubricants may be the same type and/or form or they may be different. In preferred embodiments, the one or more lubricant layers are preferably substantially separate and distinct layers.

In one embodiment, a preferred backup board comprises an HDF core, a substantially separate and distinct layer of lubricant saturated paper on each side of the core, followed by two outer shells, one on each side of the board. For example, see FIG. 1. In another embodiment, a preferred backup board comprises an HDF core, a paper layer on each side of the core, a substantially separate and distinct layer of lubricant saturated paper layer on top of each paper layer, and two outer shells, one on each side of the board. For example, see FIG. 2.

In another embodiment, a preferred backup board comprises an HDF core, a substantially separate and distinct layer of extruded lubricant on each side of the core, and two outer shells, one on each side of the board. For example, see FIGS. 4 and 5. In another embodiment, a preferred backup board comprises an HDF core, a paper layer on each side of the core, a substantially separate and distinct layer of extruded lubricant on top each paper layer, and two outer shells, one on each side of the board. In another embodiment, a preferred backup board comprises an HDF core, a substantially separate and distinct layer of extruded lubricant on one side of the core, followed by an outer shell. For example, see FIG. 6. In another embodiment, a preferred backup board comprises an HDF core, a resistance sheet on one side, a substantially separate and distinct layer of extruded lubricant on top of the resistance sheet, and an outer shell on top of the resistance sheet. For example, see FIG. 7.

In another embodiment, a preferred backup board comprises an HDF core, a paper layer on each side of the core, a substantially separate and distinct layer of lubricant saturated paper layer on top each paper layer, and two outer shells, one on each side of the board. In another embodiment, a preferred backup board comprises an HDF core, a substantially separate and distinct layer of extruded lubricant on each side of the core, and two outer shells, one on each side of the board. In another embodiment, a preferred backup board comprises an HDF core, a paper layer on each side of the core, a substantially separate and distinct layer of extruded lubricant on top each paper layer, and two outer shells, one on each side of the board. In another embodiment, a preferred backup board comprises an HDF core, a substantially separate and distinct layer of extruded lubricant on one side of the core, and an outer shell on top of the substantially separate and distinct lubricant layer. In another embodiment, a preferred backup board comprises an HDF core, a resistance sheet on one side, a substantially separate and distinct layer of extruded lubricant on top of the resistance sheet, and an outer shell on top of the substantially separate and distinct lubricant layer.

The layers of preferred backup and entry boards may be secured together using one or more of the following: adhesive, tabs, pins, straps, shrink wrap, tape, and other suitable securing devices. In preferred embodiments utilizing an adhesive, preferably the adhesive is a distinct layer. Further, the adhesive may cover the entire layer it is in contact with or only a portion of that layer. In one embodiment, the adhesive is preferably an epoxy. In embodiments utilizing tabs, preferably the tabs are relatively thin (low profile) so as not to raise up the surface of the printed circuit boards stacked on top of the backup board or change the flatness characteristics of the backup.

In some embodiments, all layers will be attached together and utilized as such, see for example FIGS. 1, 2, 5, and 12, while in other embodiments groups of layers may be removed and replaced thereby allowing for reuse of certain layers, see for example FIGS. 6, 7, and 8. In one embodiment, see for example FIG. 6A, the drill operator will first place the three-piece set on the drill machine followed by one or more printed circuit boards. Once the operator is finished drilling with the first set, he or she will remove the top two layers, leaving the core layer, and replace them with a new two-piece set. This allows for maximum use of each material layer and optimal contact between the drill and the substantially separate and distinct lubricant layer. Depending on the drilling requirements, it will be apparent to one of skill in the art how often the core layer will need to be replaced.

In some embodiments, repeated drilling into the core may cause the substantially separate and distinct lubricant layer to sag through the holes. In preferred embodiments, one or more resistance sheets are provided to support the substantially separate and distinct lubricant layer.

In one embodiment, as illustrated in FIG. 7A, a resistance sheet is used to provide support for the substantially separate and distinct lubricant layer. As shown in FIG. 7A an initial four-piece set is utilized. Once the operator is finished drilling with the first set, he or she will remove the top three layers, leaving the core layer, and replace them with a new three-piece set. As one of skill in the art will appreciate, various combinations of layers may be used depending on the specific drilling application.

In one embodiment, an entry board comprises a first outer shell, a substantially separate and distinct lubricant layer (e.g. extruded lubricant layer and/or lubricant saturated paper), and a second outer shell, wherein the layers are in the order recited. For example, see FIG. 9. In one preferred embodiment, the entry board comprises two or more substantially separate and distinct lubricant layers. In embodiments utilizing two or more substantially separate and distinct lubricant layers, the substantially separate and distinct lubricant layers may be the same type and/or form or they may be different. In other embodiments, the outer shell materials utilized may be the same or they may be different.

In another embodiment the entry board preferably comprises a first outer shell material, a substantially separate and distinct lubricant layer (e.g. extruded lubricant, hot melt lubricant, and/or lubricant saturated paper), and a second outer shell wherein the layers are in the order recited and include adhesive between each layer. In another embodiment, the entry board comprises two or more layers of substantially separate and distinct lubricant layers between the two outer shells, wherein adhesive is included between each layer. In certain embodiments wherein more than one substantially separate and distinct lubricant layer is present, the lubricants may be the same type and/or form or they. may differ. In other embodiments, the outer shell materials may be the same or they may differ. For example, one side may have one outer shell of phenolic and the other side an outer shell of aluminum. In another example, one side may have an outer shell of coated or uncoated paper while the other side may have an outer shell of phenolic or aluminum.

In other embodiments the entry board comprises a first outer shell material, a substantially separate and distinct lubricant layer (e.g. extruded lubricant hot melt lubricant, and/or lubricant saturated paper), and a second outer shell material, wherein the three layers are in the order recited and are provided to the drill operator as one bundle without adhesive. In another embodiment, the entry board comprises two or more layers of substantially separate and distinct lubricant layers (e.g. extruded lubricant, hot melt lubricant, or lubricant saturated paper) between the two outer shells. In certain embodiments wherein more than one substantially separate and distinct lubricant layer is present, the lubricants may be the same type and/or they may differ. In other embodiments, the outer shell materials may be the same or they may differ. For example, one side may have one outer shell of phenolic and the other side an outer shell of aluminum.

In other embodiments the entry board comprises a first outer shell material, a substantially separate and distinct lubricant layer (e.g. extruded lubricant hot melt lubricant, and/or lubricant saturated paper), a core, a substantially separate and distinct lubricant layer, and a second outer shell material, wherein the layers are in the order recited and adhesive is used between each layer to secure the layers. In another embodiment, the layers are in the order recited and are provided to the drill operator as one bundle without adhesive.

The various methods and techniques described above provide a number of ways to carry out the invention. Of course, it is to be understood that not necessarily all objectives or advantages described may be achieved in accordance with any particular embodiment described herein.

Furthermore, the skilled artisan will recognize the interchangeability of various features from different embodiments. Similarly, the various features and steps discussed above, as well as other known equivalents for each such feature or step, can be mixed and matched by one of ordinary skill in this art to perform methods in accordance with principles described herein.

Although the invention has been disclosed in the context of certain embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of preferred embodiments herein.

1. A backup board comprising:
a first outer shell layer;
one or more substantially separate and distinct lubricant layers;
a core material layer;
one or more substantially separate and distinct lubricant layers; and
a second outer shell layer;
wherein the one or more substantially separate and distinct lubricant layers are distinct layers;
wherein the one or more substantially separate and distinct lubricant layers are selected from the group consisting of polyethylene glycol, polypropylene glycol, and polyalkylene oxide compounds; and
wherein the layers are in the order recited.

2. The backup board of claim 1 wherein said core material is selected from the group consisting of: high-density fiberboard, medium density fiberboard, metal, metal alloys, paper, melamine, random fiber_mats, plastic, chip board, particle board, phenolic, phenolic supported with paper, cloth, or glass fiber, solid phenolic sheets, laminated phenolic sheets.

3. The backup board of claim 1, wherein said core material has a thickness range from about 0.0001 inches to about 0.125 inches.

4. The backup board of claim 3, wherein said core material has a thickness range from about 0.085 inches to about 0.095 inches.

5. The backup board of claim 1 wherein said substantially separate and distinct lubricant layer thickness ranges from about 0.0001 inches to about 0.125 inches.

6. The backup board of claim 5 wherein said substantially separate and distinct lubricant layer thickness is about 0.003 inches.

7. The backup board of claim 1 wherein said lubricant is in a form selected from the group consisting of: an extruded lubricant layer, a hot melt coating lubricant layer, a cast hot melt lubricant layer, a lubricant saturated paper layer.

8. The backup board of claim 1 wherein said outer shell comprises one or more of the following: aluminum, aluminum alloys, copper, resin, film, resin film, melamine, phenolic, UV cured film, plastic, acrylic, polyurethane, resin impregnated paper, coated paper, uncoated paper.

9. The backup board of claim 8 wherein the coating on said coated paper is selected from the group consisting of epoxy, plastic, melamine, ultra violet curable film, polyurethane, and resin.

10. The backup board of claim 1 wherein said outer shell thickness ranges from about 0.0001 inches to about 0.03 inches.

11. The backup board of claim 1 wherein the core material, the one or more substantially separate and distinct lubricant layers, and the outer shell are attached using one or more of the following: adhesive, pins, straps, shrink wrap, tape.

12. The backup board of claim 1 further comprising one or more paper layers between the core material and the one or more substantially separate and distinct lubricant layers.

13. An entry board comprising:
a first outer shell layer;
one or more substantially separate and distinct lubricant layers; and
a second outer shell layer;
wherein the one or more substantially separate and distinct lubricant layers are distinct layers;
wherein the one or more substantially separate and distinct lubricant layers are selected from the group consisting of polyethylene glycol, polypropylene glycol, and polyalkylene oxide compounds; and
wherein the layers are in the order recited.

14. The entry board of claim 13 wherein said substantially separate and distinct lubricant layer thickness ranges from about 0.0001 inches to about 0.03 inches.

15. The entry board of claim 14 wherein said substantially separate and distinct lubricant layer thickness is about 0.003 inches.

16. The entry board of claim 13 wherein said lubricant is in a form selected from the group consisting of: an extruded lubricant layer, a hot melt coating lubricant layer, a cast hot melt lubricant layer, a lubricant saturated paper layer.

17. The entry board of claim 13 wherein said outer shell comprises one or more of the following: aluminum, aluminum alloys, copper, resin, film, resin film, melamine, phenolic, UV cured film, plastic, acrylic, polyurethane, resin impregnated paper, coated paper, uncoated paper.

18. The entry board of claim 17 wherein the coating on said coated paper is selected from the group consisting of epoxy, plastic, melamine, ultra violet curable film, polyurethane, and resin.

19. The entry board of claim 13 wherein said outer shell thickness ranges from about 0.0001 inches to about 0.03 inches.

20. The entry board of claim 13 wherein the one or more substantially separate and distinct lubricant layers, and the outer shell are attached using one or more of the following: adhesive, pins, straps, shrink wrap, tape.

21. The entry board of claim 13 further comprising one or more core layers between the outer shell and the one or more substantially separate and distinct lubricant layers.

22. A method of drilling printed circuit boards comprising:
placing a backup board on a drill machine followed by one or more printed circuit boards; and
drilling said circuit boards;
wherein said backup board comprises a first outer shell layer;
one or more substantially separate and distinct lubricant layers;
a core material layer;
one or more substantially separate and distinct lubricant layers; and
a second outer shell layer;
wherein the one or more substantially separate and distinct lubricant layers are selected from the group consisting of polyethylene glycol, polypropylene glycol, and polyalkylene oxide compounds; and
wherein the layers are in the order recited.

23. The method of claim 22, wherein said core material is selected from the group consisting of: high-density fiberboard, medium density fiberboard, metal, metal alloys, paper, melamine, random fiber_mats, plastic, chip board, particle board, phenolic, phenolic supported with paper, cloth, or glass fiber, solid phenolic sheets, laminated phenolic sheets

24. The method of claim 22, wherein said core material has a thickness range from about 0.0001 inches to about 0.125 inches.

25. The method of claim 24, wherein said core material has a thickness range from about 0.085 inches to about 0.095 inches.

26. The method of claim 22, wherein said substantially separate and distinct lubricant layer thickness ranges from about 0.0001 inches to about 0.125 inches.

27. The method of claim 26 wherein said substantially separate and distinct lubricant layer thickness is about 0.003 inches.

28. The method of claim 22, wherein said lubricant is in a form selected from the group consisting of: an extruded lubricant layer, a hot melt coating lubricant layer, a cast hot melt lubricant layer, a lubricant saturated paper layer.

29. The method of claim 22, wherein said outer shell comprises one or more of the following: aluminum, aluminum alloys, copper, resin, film, resin film, melamine, phenolic, UV cured film, plastic, acrylic, polyurethane, resin impregnated paper, coated paper, uncoated paper.

30. The method of claim 22, wherein the coating on said coated paper is selected from the group consisting of epoxy, plastic, melamine, ultra violet curable film, polyurethane, and resin.

31. The method of claim 22, wherein said outer shell thickness ranges from about 0.0001 inches to about 0.03 inches.

32. The method of claim 22, wherein the core material, the one or more substantially separate and distinct lubricant layers, and the outer shell are attached using one or more of the following: adhesive, pins, straps, shrink wrap, tape.

33. The method of claim 22, further comprising one or more paper layers between the core material and the one or more substantially separate and distinct lubricant layers.

34. The method of claim 22 further comprising placing an entry board on top of the printed circuit boards prior to drilling wherein said entry board comprises:
a first outer shell layer;
one or more substantially separate and distinct lubricant layers; and
a second outer shell layer;
wherein the one or more substantially separate and distinct lubricant layers are selected from the group consisting of polyethylene glycol, polypropylene glycol, and polyalkylene oxide compounds; and
wherein the layers are in the order recited.

35. The method of claim 34 wherein said substantially separate and distinct lubricant layer thickness of the entry board ranges from about 0.0001 inches to about 0.125 inches.

36. The method of claim 34 wherein said substantially separate and distinct lubricant layer thickness of the entry board is about 0.003 inches.

37. The method of claim 34 wherein said lubricant of the entry board is in a form selected from the group consisting of: an extruded lubricant layer, a hot melt coating lubricant layer, a cast hot melt lubricant layer, a lubricant saturated paper layer.

38. The method of claim 34 wherein said entry board outer shell comprises one or more of the following: aluminum, aluminum alloys, copper, resin, film, resin film, melamine, phenolic, UV cured film, plastic, acrylic, polyurethane, resin impregnated paper, coated paper, uncoated paper.

39. The method of claim 34 wherein the coating on said entry board coated paper is selected from the group consisting of epoxy, plastic, melamine, ultra violet curable film, polyurethane, and resin.

40. The method of claim 34 wherein said entry board outer shell thickness ranges from about 0.0001 inches to about 0.03 inches.

41. The method of claim 34 wherein the one or more entry board substantially separate and distinct lubricant layers, and the outer shell are attached using one or more of the following: adhesive, pins, straps, shrink wrap, tape.

42. The method of claim 34 further comprising one or more paper layers between the outer shell and the one or more substantially separate and distinct lubricant layers of the entry board.
